(19) United States
(12) Patent Application Publication
(10) Pub. No.: US 2007/0068579 A1
(43) Pub. Date: Mar. 29, 2007

(54) Non-return valve

(75) Inventor: Yang Tiao Hsing, Lugang Township (TW)

Correspondence Address: TROXELL LAW OFFICE PLLC, SUITE 1404, 5205 LEESBURG PIKE, FALLS CHURCH, VA, 22041, US

(73) Assignee: Yang Fa Men Industrial Co., Ltd.

(21) Appl. No.: 11/233,051

(22) Filed: Sep. 23, 2005

(51) Int. Cl. F16K 15/03

(52) U.S. Cl. 137/527.8

(57) ABSTRACT

A non-return valve includes a flap and a valve body. The flap has one side formed with a pivot connector pivotally connected with the valve body and the other side formed integral with a weight. After the flap is pushed open by the pushing force of fluid and the pushing force of the fluid vanishes, the flap without being pressed by any force will be actuated by its own weight to quickly move down and tightly close the valve port of the valve body, having excellent effect of stopping fluid from flowing reversely and leaking out of the port.

### BACKGROUND OF THE INVENTION

1. Field of the Invention

This invention relates to a non-return valve, particularly to one formed integral with a weight at the opposite side of its pivot connector for shifting the center of gravity of a flap to its outer side. Thus, when the flap is not pressed by any force, it can be actuated by its own weight to quickly recover its original position and tightly close the valve port of the valve body, having excellent effect of stopping fluid from flowing reversely.

2. Description of the Prior Art

A conventional non-return valve functions to permit fluid to flow in a single direction and prevent the fluid from flowing reversely. When the pressure of the fluid passing through a system is higher than the weight of the valve flap, the valve flap will be pushed open, and when there is any fluid flowing reversely, the valve will be actuated to close the valve port by its own weight and by the pressure of the refluxing fluid to stop the fluid from flowing back.

However, referring to FIG. 1, the weight of the flap of the conventional non-return valve 1 is evenly distributed over every position of the flap 1, and the center of gravity of the flap 1 is at its central portion. Therefore, after fluid flows through the valve port, and stops flowing, the flap is to be actuated to recover its original position, with the moment of force for pressing down the valve 1 to close being insufficient. Under this condition, when the flap 1 is closed on the valve port, the circumferential edge of the flap 1 cannot completely be fitted closely with the valve port, and consequently refluxing fluid being pressed by no force still may leak out of the valve port. In addition, the conventional flap 1 has one end formed with a rectangular pivot lug 2 to be pivotally connected with the valve body by a pivot. Since the axial length of the pivot lug 2 is quite long; therefore, boring an axial pivot hole for the pivot lug 2 requires high precision; otherwise, the pivot hole 3 is most likely to become oblique and the flap cannot be assembled with the valve body precisely, resulting in difficulty in second-time processing of the flap 1, increasing cost in processing and lowering the percentage of qualified products.

### SUMMARY OF THE INVENTION

The objective of the invention is to offer a non-return valve having a disk-shaped flap, which has one side formed with a pivot connector to be axially connected with the pivotal member of the valve body so that the flap can be actuated to close or open a port. When the flap is closed, fluid can be stopped from flowing reversely. The flap has the opposite side of its pivot connector formed integral with a weight for shifting the center of gravity of the flap to its outer side. Thus, when the flap is not pressed by any force, it can automatically recover its original position by its own weight, enabling the flap to be closed on the valve port closely to stop fluid from flowing reversely and leaking out of the port.

Specifically, after the flap of the non-return valve of the present invention is pushed open upward by a pushing force of fluid and the pushing force of the fluid vanishes, the flap with its weight on the outer side will be forced by its own weight to quickly move down and tightly close the valve port, having excellent effect of stopping fluid from flowing reversely.

### BRIEF DESCRIPTION OF DRAWINGS

This invention will be better understood by referring to the accompanying drawings, wherein:

FIG. 1 is a perspective view of a conventional non-return valve;

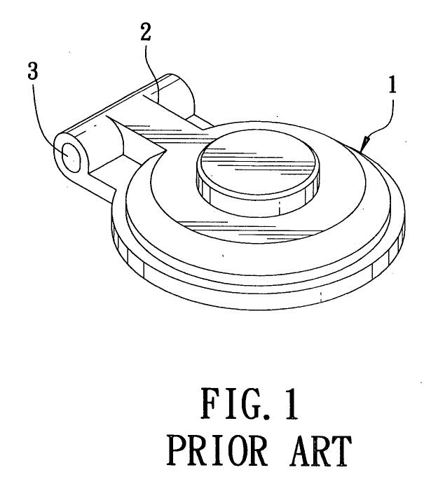

FIG. 2 is a perspective view of a non-return valve in the present invention;

FIG. 3 is a partial upper cross-sectional view of the non-return valve in the present invention;

FIG. 4 is a side cross-sectional view of the non-return valve having its flap pushed open by fluid in the present invention;

FIG. 5 is a side cross-sectional view of the non-return valve with its flap in a closed condition by its own weight in the present invention; and

FIG. 6 is a side cross-sectional view of the non-return valve having its flap in a condition with its location of corrected in micro degree by means of its pivot hole and a pivot in the present invention.

### DETAILED DESCRIPTION OF THE PREFERRED EMBODIMENT

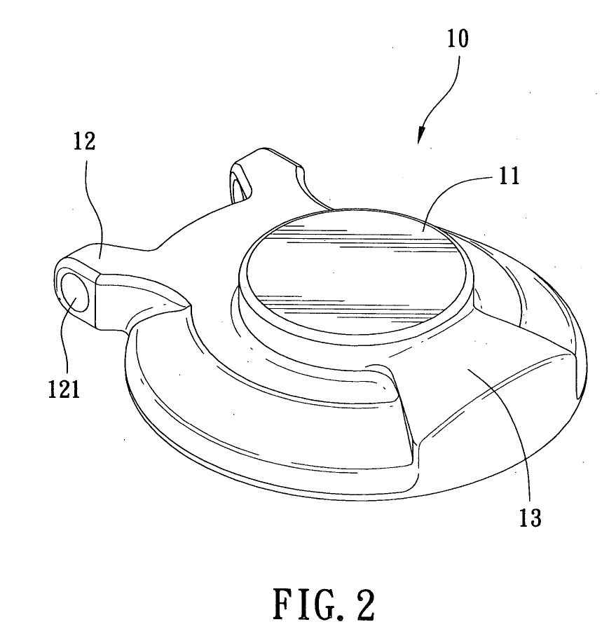

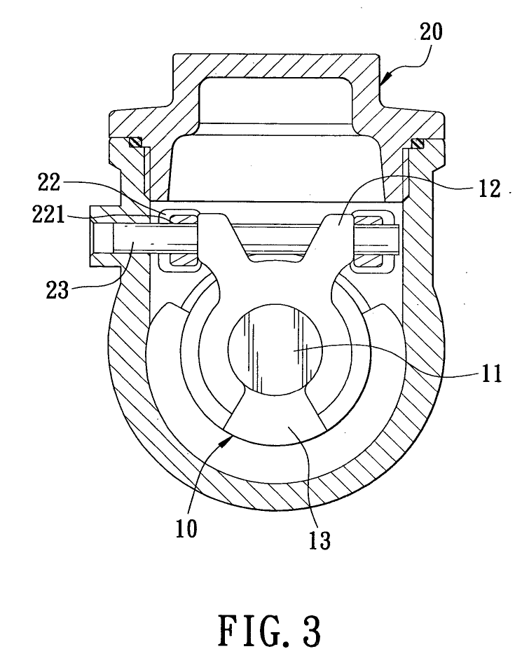

A preferred embodiment of a non-return valve in the present invention, as shown in FIGS. 2, 3 and 4, includes a flap 10 and a valve body 20 combined together.

The flap 10 is a double-layer concentric disk body cast in shape, having its central portion formed with a round block 11 having one side of its circumferential edge formed with a pivot connector composed of two pivot lugs 12 positioned symmetrically. The two pivot lugs 12 respectively have the axial center bored with an oval co-axial pivot hole 121 having a longer distance between its upper and lower end. Further, the round block 11 of the flap 1 has the opposite side of its pivot lugs 12 formed with a weight 13 extending to reach the outer circumferential edge of the flap 10. By the weight 13, the center of gravity of the valve 10 is shifted to the opposite side of its pivot lug 12 so as to augment the moment of force of the flap 10. Thus, when the flap 10 is not pressed by any force, it can automatically and quickly recover its original position and tightly close the valve port 21 by its own weight, able to enhance the effect of close fitting between the flap 10 and the valve port 2, preventing fluid from reversely flowing and leaking out of the valve port 21.

The valve body 20 is a hollow tubular body formed integral, having the valve port 21 axially formed at a preset position. The valve port 21 has it lower edge provided with two projecting lugs 22 positioned symmetrically to form a pivotal member. The two projecting lugs 22 respectively have a central portion bored with a pivot hole 221, and one of the two pivot holes 221 extends out of the valve body 20 for facilitating a pivot 23 to be inserted through the two pivot holes 121 of the two pivot lugs 12 and also through the two pivot holes 221 of the two projecting lugs 22 so as to assemble the flap 10 in the valve body 20 and enable the valve to turn therein.

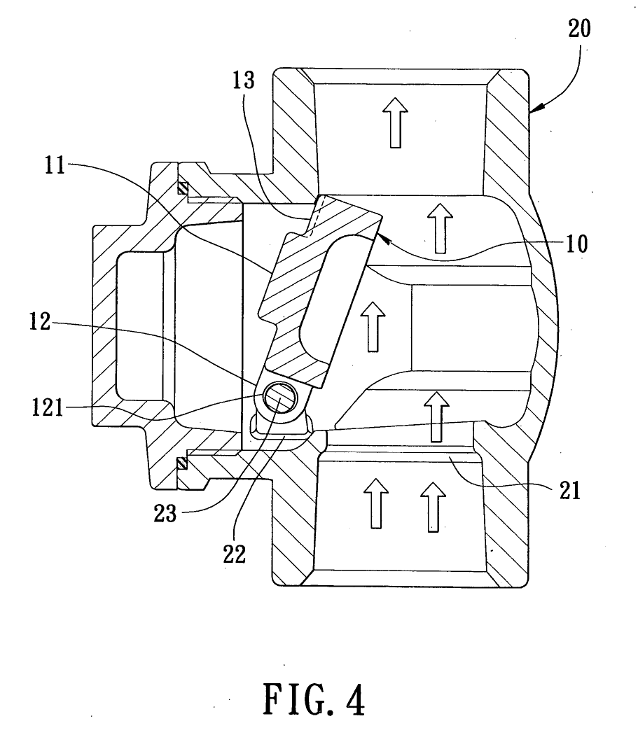

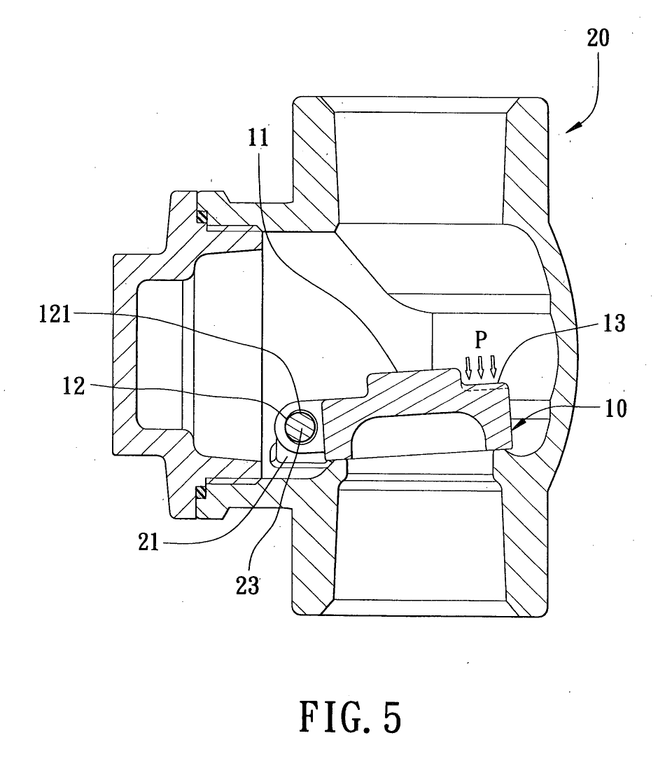

In using, referring to FIGS. 4, and 5, when the fluid in the valve body 20 flows upward, the flap 10 will be pushed open by the pushing force of the fluid to permit the fluid to flow to the upper side of the valve body 20. When the pushing force of the fluid vanishes, the flap 10 will be forced by its own weight to automatically recover its original position. At this time, since the center of gravity of the flap 10 is at the opposite side of the pivot lugs 12, the moment of force of the valve 10 is greatly lengthened. By so designing, it is possible to accelerate the valve 10 to recover its original position and shorten time of stopping fluid from flowing reversely and also enhance efficiency of the non-return valve.

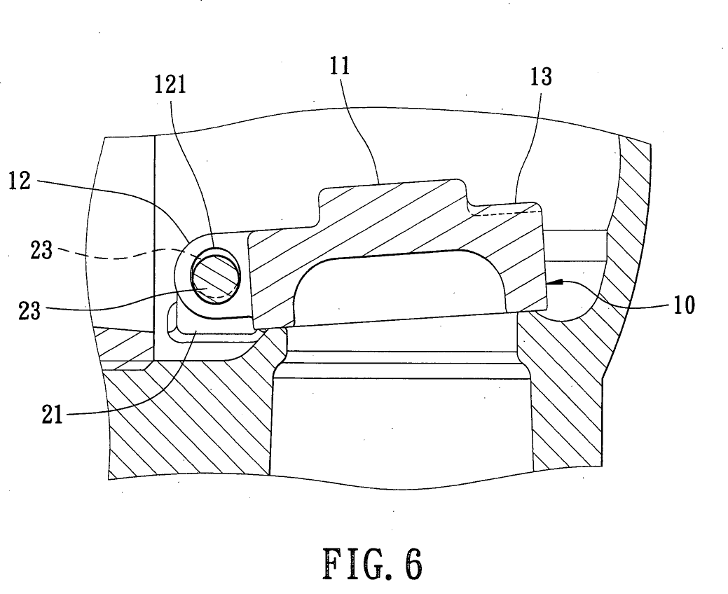

Specifically, When the flap 10 is not pressed by any force, it can automatically recover its original position, and since the center of gravity of the flap 10 is at the opposite side of its pivot lugs 12, the flap 10 is added with an extra weight (P) to be tightly closed on the valve port 21, having excellent effect of leak prevention. Further, referring to FIG. 6, after the pivot 23 is inserted, in the pivot holes 121 of the pivot lugs 12 of the valve 10 from the outer side of the valve body 20, the micro error produced therebetween can automatically be corrected by the flap 10 itself so as to always maintain close and tight fitting between the flap 10 and the valve port 21.

As can be understood from the above description, this invention has the following advantages.

1. The flap has one side additionally formed with a weight for shifting the center of gravity of the flap to its outer end; therefore, when the flap is not pressed by any force, it can be forced by its own weight and its biased center of gravity to automatically and quickly recover its original position, accelerating the flap to recover and heightening the efficiency of the non-return valve. In addition, the center of gravity of the valve is at the opposite side of the pivotal lugs; therefore, when the flap is closed on the valve port, the weight enables the flap to close the valve port comparatively tightly to prevent fluid from leaking.

2. The pivot connector of the flap is formed integral with two pivot lugs positioned symmetrically and respectively bored with a co-axial pivot hole, able to reduce material needed for casting and save cost for second-time processing. Additionally, the pivot holes of the two pivot lugs are oval-shaped so that a pivot can conveniently be inserted therein, and the micro error produced between the pivot holes and the pivot can automatically be corrected by the flap itself, able to always maintain close fitting between the flap and the valve port.

In addition, the valve of this invention is made by lost-wax casting, with the place where the weight is located serving as a pouring gate for sending casting material into a lost-wax mold. Since the weight-balancing block is formed to extend to one side of the circumferential edge of the flap; therefore, the pouring gate is comparatively large in its diameter for facilitating the casting material to be poured into the lost-wax mold, able to increase the percentage of success in shaping and elevate the percentage of qualified products.

While the preferred embodiment of the invention has been described above, it will be recognized and understood that various modifications may be made therein and the appended claims are intended to cover all such modifications that may fall within the spirit and scope of the invention.

I claim:

1. A non-return valve comprising a flap and a valve body, said flap shaped as a disk body and having one side formed with a pivot connector, said pivot connector combined with a pivotal member of said valve body, said flap functioning to close or open a port of said valve body, said flap actuated to tightly close said port to stop fluid from flowing reversely: and,
Characterized by a weight formed integral on the opposite side of, said pivot connector of said flap, said weight shifting the center of gravity of said flap to the outer side, said flap automatically forced to recover its original position by its own weight when said flap is not pressed by any force, said weight at the outer side of said flap enabling said flap to be tightly closed on said valve port, able to stop fluid from leaking.

2. The non-return valve as claimed in claim 1, wherein said flap has its central portion formed with a round block, said weight on an opposite side of said pivot connector on said round block extending outward to reach the outer circumferential edge of said flap.

3. The non-return valve as claimed in claim 1, wherein said pivot connector of said flap is composed of two pivot lugs protruding outward and positioned symmetrically, said two pivot lugs respectively bored with a co-axial pivot hole, the pivotal member of said valve body provided with projecting lugs positioned symmetrically, said two projecting lugs of said valve body respectively having the center portion bored with a pivot hole, one of said two pivot holes extending out of said valve body for facilitating a pivot to be inserted therein, said pivot inserted through said two pivot holes of said two pivot lugs and said two pivot holes of said two projecting lugs to assemble said flap on said valve body.

4. The non-return valve as claimed in claim 1, wherein said two pivot holes of said two pivot lugs of said flap are oval, having a comparatively long distance between its upper and lower end, said oval holes of said flap enabling said flap to correct micro errors produced after said pivot pivotally inserted through said pivot holes, letting said flap closed on said valve port closely and accurately.
